(19) United States
(12) Patent Application Publication
(10) Pub. No.: US 2026/0062613 A1
(43) Pub. Date: Mar. 5, 2026

(54) COMPOSITION, METHOD OF TREATING METAL-CONTAINING FILM BY USING THE COMPOSITION, AND METHOD OF PREPARING SEMICONDUCTOR DEVICE BY USING THE COMPOSITION

(71) Applicant: Samsung Electronics Co., Ltd., Suwon-si (KR)

(72) Inventors: Kum Hee LEE, Suwon-si (KR); Byungjoon KANG, Suwon-si (KR); Daihyun KIM, Suwon-si (KR); Youngchan KIM, Suwon-si (KR); Jungah KIM, Suwon-si (KR); Insun PARK, Suwon-si (KR); Heesuk WOO, Suwon-si (KR); Kyuyoung HWANG, Suwon-si (KR)

(73) Assignee: Samsung Electronics Co., Ltd., Suwon-si (KR)

(21) Appl. No.: 19/319,073

(22) Filed: Sep. 4, 2025

(30) Foreign Application Priority Data
Sep. 4, 2024 (KR) 10-2024-0120311
Aug. 29, 2025 (KR) 10-2025-0122133

(51) Int. Cl. C09K 13/00; C23G 1/06; H01L 21/02; H01L 21/465

(52) U.S. Cl. CPC C09K 13/00; C23G 1/066

(57) ABSTRACT

Provided is a composition, a method of treating a metal-containing film by using the composition, and a method of preparing a semiconductor device by using the composition. The composition may include hydrofluoric acid and an etching controller and the composition may not include hydrogen peroxide. The etching controller may include at least one compound represented by Formula 1:

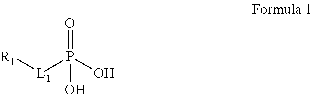

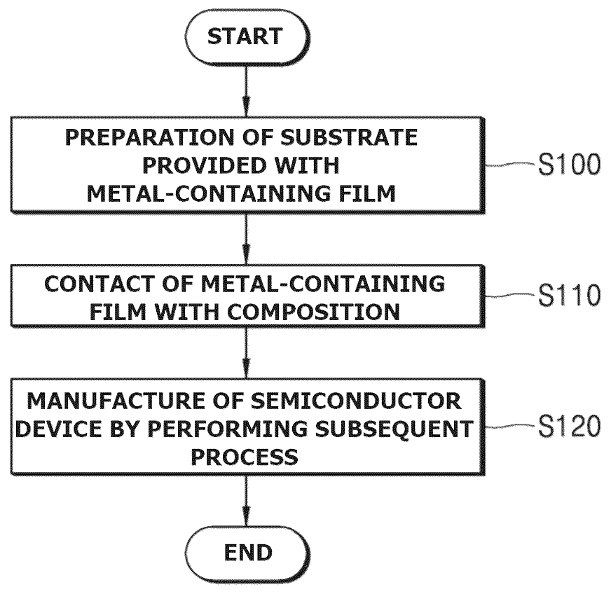

A description of Formula 1 is provided in the present specification.

### CROSS-REFERENCE TO RELATED APPLICATION

This application is based on and claims priority under 35 U.S.C. § 119 to Korean Patent Applications Nos. 10-2024-0120311, filed on Sep. 4, 2024 and 10-2025-0122133, filed on Aug. 29, 2025, in the Korean Intellectual Property Office, the disclosure of which is incorporated by reference herein in its entirety.

### BACKGROUND

### 1. Field

The disclosure relates to a composition, a method of treating a metal-containing film by using the composition, and/or a method of manufacturing a semiconductor device by using the composition.

### 2. Description of the Related Art

To satisfy the demands of consumers for semiconductor devices with excellent performance and low prices, there may be a need for an increase in integration and/or an improvement in reliability of semiconductor devices. As the integration of semiconductor devices increases, damage to components of semiconductor devices during a manufacturing process thereof may have a greater effect on the reliability and/or electrical characteristics of the semiconductor devices. In particular, in the process of manufacturing a semiconductor device, various processing processes, such as etching, cleaning, and polishing, may be performed on a film (e.g., a metal-containing film). In this regard, to more effectively perform a treatment process on a metal-containing film, there may be an ongoing need for a composition having an appropriate etching rate or the like.

### SUMMARY

Provided are a composition capable of more effectively controlling an etching rate of various metal-containing films, such as a metal-containing film including a metal oxide, a method of treating a metal-containing film by using the composition, and/or a method of preparing a semiconductor device by using the composition.

Additional aspects will be set forth in part in the description which follows and, in part, will be apparent from the description, or may be learned by practice of the presented embodiments of the disclosure.

According to an example embodiment of the disclosure, a composition may include:
hydrofluoric acid and an etching controller, where the composition may not substantially include hydrogen peroxide.

The etching controller may include at least one compound represented by Formula 1:

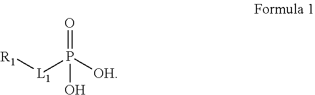

In Formula 1,
L₁ may be a single bond, *—O—*′, *—S—*′, or a C₁-C₁₀ alkylene group,
R₁ may be *—OH, *—C(═O)—OH, *—P(═O)(OH)₂, or *—N(L₁₁-R₁₁)(L₁₂-R₁₂),
L₁₁ and L₁₂ may each independently be a single bond or a C₁-C₁₀ alkylene group,
R₁₁ and R₁₂ may each independently be hydrogen, *—OH, *—C(═O)—OH, *—P(═O)(OH)₂, or *—NH₂,
in L₁, L₁₁ and L₁₂, at least one hydrogen in the C₁-C₁₀ alkylene group may optionally be substituted with a C₁-C₁₀ alkyl group, *—OH, *—C(═O)—OH, *—P(═O)(OH)₂, or *—NH₂,
* and *′ each indicate a binding site to a neighboring atom, and
a number of groups represented by *—P(═O)(OH)₂ in Formula 1 may be 1, 2, or 3.

According to an example embodiment of the disclosure, a method of treating a metal-containing film may include:
preparing a substrate including a metal-containing film, and
contacting the metal-containing film with the composition.

According to an example embodiment of the disclosure, a method of preparing a semiconductor device may include
preparing a substrate including a metal-containing film,
contacting the metal-containing film with the composition, and
preparing the semiconductor device by performing at least one subsequent manufacturing process.

### BRIEF DESCRIPTION OF THE DRAWING

The above and other aspects, features, and advantages of certain embodiments of the disclosure will be more apparent from the following description taken in conjunction with FIGURE which is a process flowchart illustrating a method of preparing a semiconductor device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the FIGURE, to explain aspects. As used herein, the singular forms “a,” “an” and “the” are intended to include the plural forms as well, unless the context clearly indicates otherwise.

As used herein, the term “and/or” includes any and all combinations of one or more of the associated listed items. Expressions such as “at least one of,” when preceding a list of elements, modify the entire list of elements and do not modify the individual elements of the list. For example, “at least one of A, B, and C,” and similar language (e.g., “at least one selected from the group consisting of A, B, and C” and “at least one of A, B, or C”) may be construed as A only, B only, C only, or any combination of two or more of A, B, and C, such as, for instance, ABC, AB, BC, and AC.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

### Metal-Containing Film

A metal included in an metal-containing film may be an alkali metal (e.g., sodium (Na), potassium (K), rubidium (Rb), cesium (Cs), etc.), an alkaline earth metal (e.g., beryllium (Be), magnesium (Mg), calcium (Ca), strontium (Sr), barium (Ba), etc.), a lanthanide metal (e.g., lanthanum (La), europium (Eu), terbium (Tb), ytterbium (Yb), etc.), a transition metal (e.g., scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), iron (Fe), ruthenium (Ru), osmium (Os), cobalt (Co), rhodium (Rh), nickel (Ni), copper (Cu), silver (Ag), zinc (Zn), etc.), a post-transition metal (e.g., aluminum (Al), gallium (Ga), indium (In), thallium (Tl), tin (Sn), bismuth (Bi), etc.), or any combination thereof.

In an embodiment, the metal included in the metal-containing film may include Ti, In, Al, Co, La, Sc, Ga, W, Mo, Ru, Zn, Hf, Cu, or any combination thereof.

The metal-containing film may include a metal, metal nitride, metal oxide, metal oxynitride, or a combination thereof.

In an embodiment, the metal-containing film may include a metal, metal nitride, metal oxide, metal oxynitride, or any combination thereof, and a metal included in each of the metal, the metal nitride, the metal oxide, and the metal oxynitride may include Ti, In, Al, Co, La, Sc, Ga, W, Mo, Ru, Zn, Hf, Cu, or any combination thereof.

In one or more embodiments, the metal-containing film may include a metal oxide, and the metal oxide may include: i) In, Ga, Zn, or any combination thereof; or ii) Al.

In one or more embodiments, the metal-containing film may include indium gallium zinc oxide (IGZO), aluminum oxide (e.g., Al₂O₃), or a combination thereof.

In the IGZO, an atomic ratio or weight ratio of In, Ga, and Zn may be varied. For example, the amount of Zn in the IGZO may be in a range of about 20 wt % to about 40 wt %, for example, may be 30 wt %.

In one or more embodiments, the metal-containing film may include a metal. In an embodiment, the metal-containing film may include Al.

In one or more embodiments, the metal-containing film may include metal nitride.

The metal included in the metal nitride may include In, Ti, Al, La, Sc, Ga, Zn, Hf, or any combination thereof.

In an embodiment, the metal-containing film may include titanium nitride. The titanium nitride may further include In, Al, La, Sc, Ga, Hf, Zn, W, silicon (Si), or any combination thereof. In one or more embodiments, the metal-containing film may include titanium nitride (TiN), TiN further including Al (e.g., titanium aluminum nitride (for example, TiAlN)), TiN further including La (for example, TiLaN), TiN further including Si (for example, TiSiN), or the like.

In one or more embodiments, the metal-containing film may include the metal nitride and the metal oxide.

In one or more embodiments, the metal-containing film may further include, in addition to the aforementioned metal, a metalloid (e.g., boron (B), Si, germanium (Ge), arsenic (As), antimony (Sb), tellurium (Te), etc.), a non-metal (e.g., nitrogen (N), phosphorus (P), oxygen (O), sulfur (S), selenium (Se), etc.), or any combination thereof.

For example, the metal-containing film may further include silicon oxide.

The metal-containing film may have a single-layer structure including at least one type of materials or a multi-layer structure or three-dimensional pattern structure including different materials from each other.

### Composition

A composition may include hydrofluoric acid (HF) and an etching controller, and may not substantially include hydrogen peroxide. For example, the composition may include hydrofluoric acid (HF) and an etching controller, and may not include hydrogen peroxide. The etching controller may be understood by referring to the related description to be presented later.

The composition may be used in various treatment processes, such as etching, cleaning, polishing, etc., for the metal-containing film.

The composition may further include water.

Although not particularly limited to a specific theory, hydrogen peroxide may degrade the stability of the composition and the effectiveness of the etching controller.

### Hydrofluoric Acid

The hydrofluoric acid may serve to remove resides on the surface of the metal-containing film and if necessary, etch a portion of the metal-containing film.

An amount (weight) of the hydrofluoric acid may be, for example, in a range of about 0.01 wt % to about 2 wt %, about 0.01 wt % to about 1.5 wt %, about 0.01 wt % to about 1.0 wt %, about 0.01 wt % to about 0.5 wt %, about 0.01 wt % to about 0.2 wt %, about 0.01 wt % to about 0.1 wt %, about 0.01 wt % to about 0.09 wt %, about 0.01 wt % to about 0.08 wt %, about 0.01 wt % to about 0.07 wt %, about 0.01 wt % to about 0.05 wt %, about 0.03 wt % to about 2 wt %, about 0.03 wt % to about 1.5 wt %, about 0.03 wt % to about 1.0 wt %, about 0.03 wt % to about 0.5 wt %, about 0.03 wt % to about 0.2 wt %, about 0.03 wt % to about 0.1 wt %, about 0.03 wt % to about 0.09 wt %, about 0.03 wt % to about 0.08 wt %, about 0.03 wt % to about 0.07 wt %, about 0.03 wt % to about 0.05 wt %, about 0.05 wt % to about 0.07 wt %, about 0.04 wt % to about 2 wt %, about 0.04 wt % to about 1.5 wt %, about 0.04 wt % to about 1.0 wt %, about 0.04 wt % to about 0.5 wt %, about 0.04 wt % to about 0.2 wt %, about 0.04 wt % to about 0.1 wt %, about 0.04 wt % to about 0.09 wt %, about 0.04 wt % to about 0.08 wt %, about 0.04 wt % to about 0.07 wt %, or about 0.04 wt % to about 0.06 wt %, with respect to 100 wt % of the composition.

When the amount of the hydrofluoric acid is within the ranges above, residue on a surface of the metal-containing film may be effectively removed without substantial damage to the metal-containing film.

### Etching Controller

The etching controller may serve to control an etching rate or the like through an interaction with various metal atoms included in the metal-containing film, which is a target film to be treated. For example, when the metal-containing film includes a metal oxide, the etching controller may serve to limit and/or suppress etching of the metal oxide.

The etching controller may include at least one compound represented by Formula 1:

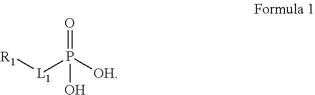

In Formula 1,
L₁ may be a single bond, *—O—*′, *—S—*′, or a C₁-C₁₀ alkylene group,
R₁ may be *—OH, *—C(═O)—OH, *—P(═O)(OH)₂, or *—N(L₁₁-R₁₁)(L₁₂-R₁₂),
L₁₁ and L₁₂ may each independently be a single bond or a C₁-C₁₀ alkylene group,
R₁₁ and R₁₂ may each independently be hydrogen, *—OH, *—C(═O)—OH, *—P(═O)(OH)₂, or *—NH₂,
in L₁, L₁₁ and L₁₂, at least one hydrogen in the C₁-C₁₀ alkylene group may optionally be substituted with a C₁-C₁₀ alkyl group, *—OH, *—C(═O)—OH, *—P(═O)(OH)₂, or *—NH₂,
and *′ each indicate a binding site to a neighboring atom, and
a number of groups represented by *—P(═O)(OH)₂ in Formula 1 may be 1, 2, or 3.

In an embodiment, L₁ in Formula 1 may be:
a single bond, *—O—*′, or a C₁-C₆ alkylene group; or
a C₁-C₆ alkylene group substituted with at least one of a C₁-C₁₀ alkyl group, *—OH, *—C(═O)—OH, *—P(═O)(OH)₂, and *—NH₂.

In one or more embodiments, L₁ in Formula 1 may be:
a single bond, *—O—*′, or a methylene group; or
a methylene group substituted with at least one of a C₁-C₁₀ alkyl group, *—OH, *—C(═O)—OH, *—P(═O)(OH)₂, and *—NH₂.

In one or more embodiments, R₁ in Formula 1 may be *—OH, *—C(═O)—OH, or *—P(═O)(OH)₂.

In one or more embodiments, in Formula 1, R₁ may be *—N(L₁₁-R₁₁)(L₁₂-R₁₂),
L₁₁ and L₁₂ may each independently be:
a single bond or a C₁-C₆ alkylene group; or
a C₁-C₆ alkylene group substituted with at least one of a C₁-C₁ alkyl group, *—OH, *—C(═O)—OH, *—P(═O)(OH)₂, and *—NH₂,
R₁₁ may be hydrogen or *—P(═O)(OH)₂, and
R₁₂ may be hydrogen, *—OH, *—C(═O)—OH, *—P(═O)(OH)₂, or *—NH₂.

In one or more embodiments, in Formula 1, R₁ may be *—N(L₁₁-R₁₁)(L₁₂-R₁₂), each of L₁₁ and L₁₂ may be a single bond, and each of R₁₁ and R₁₂ may be hydrogen.

In one or more embodiments, in Formula 1, R₁ may be *—N(L₁₁-R₁₁)(L₁₂-R₁₂), L₁₁ may be a methylene group, and R₁₁ may be *—P(═O)(OH)₂.

In one or more embodiments, in Formula 1, R₁ may be *—N(L₁₁-R₁₁)(L₁₂-R₁₂), each of L₁₁ and L₁₂ may be a methylene group, R₁₁ may be *—P(═O)(OH)₂, and R₁₂ may be *—C(═O)—OH or *—P(═O)(OH)₂.

In one or more embodiments, in Formula 1, R₁ may be *—N(L₁₁-R₁₁)(L₁₂-R₁₂),
L₁₁ may be a methylene group,
R₁₁ may be *—P(═O)(OH)₂,
L₁₂ may be:
a single bond or a C₁-C₆ alkylene group; or
a C₁-C₆ alkylene group substituted with at least one of a C₁-C₁ alkyl group, *—OH, *—C(═O)—OH, *—P(═O)(OH)₂, and *—NH₂, and
R₁₂ may be hydrogen or *—OH.

In one or more embodiments, the etching controller may include at least one of Compounds 1 to 13:

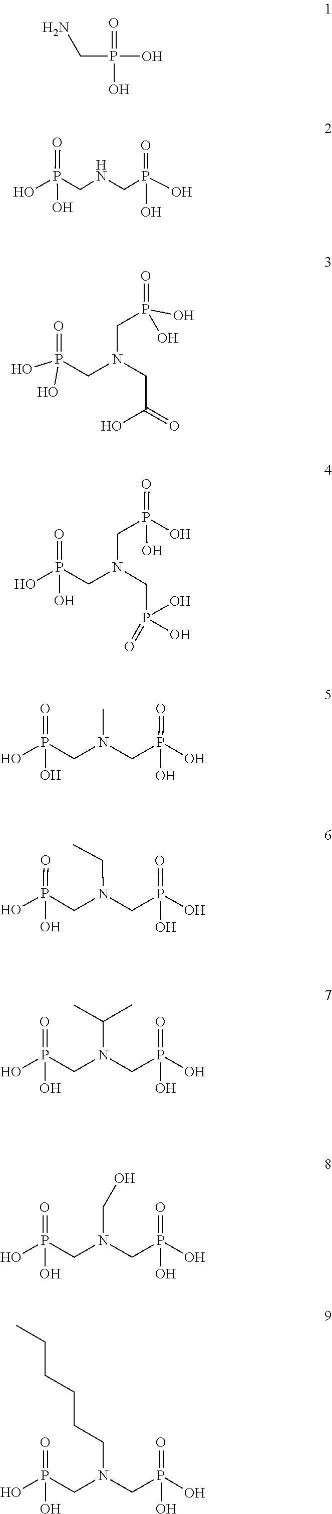

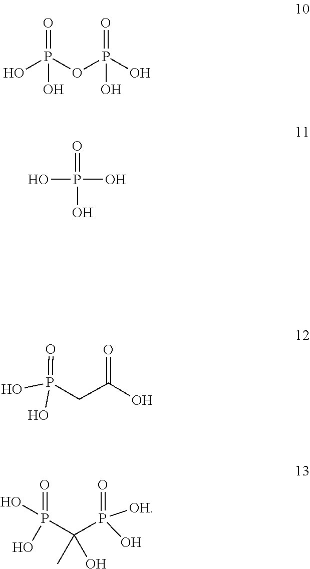

In Formula 1, the number of the group represented by *—P(═O)(OH)₂ may be 1, 2, or 3, and R₁ may be a hydrophilic group such as *—OH, *—C(═O)—OH, *—P(═O)(OH)₂, or *—N(L₁₁-R₁₁)(L₁₂-R₁₂). In this regard, for example, when the metal-containing film includes a metal oxide, the metal oxide may be more effectively protected by the compound represented by Formula 1, so that etching of the metal-containing film may be substantially limited and/or suppressed.

An amount (weight) of the etching controller may be, for example, in a range of about 0.001 wt % to about 10 wt %, about 0.001 wt % to about 7 wt %, about 0.001 wt % to about 5 wt %, about 0.005 wt % to about 10 wt %, about 0.005 wt % to about 7 wt %, about 0.005 wt % to about 5 wt %, about 0.01 wt % to about 10 wt %, about 0.01 wt % to about 7 wt %, or about 0.01 wt % to about 5 wt %, with respect to 100 wt % of the composition.

The composition may have a pH of 5.0 or less, 4.0 or less, 3.0 or less, 2.4 or less, 2.0 or less, 1.0 or less, −2.0 to 5.0, −2.0 to 4.0, −2.0 to 3.0, −2.0 to 2.4, −2.0 to 2.0, −2.0 to 1.0, −1.0 to 5.0, −1.0 to 4.0, −1.0 to 3.0, −1.0 to 2.4, −1.0 to 2.0, −1.0 to 1.0, 0.01 to 5.0, 0.01 to 4.0, 0.01 to 3.0, 0.01 to 2.4, 0.01 to 2.0, 0.01 to 1.0, 0.1 to 5.0, 0.1 to 4.0, 0.1 to 3.0, 0.1 to 2.4, 0.1 to 2.0, 0.1 to 1.0, 0.5 to 5.0, 0.5 to 4.0, 0.5 to 3.0, 0.5 to 2.4, 0.5 to 2.0, 0.5 to 1.0, 0.96 to 5.0, 0.96 to 4.0, 0.96 to 3.0, 0.96 to 2.4, 0.96 to 2.0, or 0.96 to 1.0. When the pH of the composition is within these ranges, an interaction between the etching controller and metal atoms included in the metal-containing film may be more smoothly achieved.

In an embodiment, the composition may be used in a process of treating the metal-containing film, such as an etching, cleaning, or polishing process on the metal-containing film. The metal-containing film is the same as described elsewhere herein.

In an embodiment, the composition may be used as a scavenger of an etching by-product, a scavenger of a post-etch process by-product, a scavenger of an ashing process by-product, a cleaning composition, a photoresist (PR) scavenger, an etching composition for packaging process, a cleaning agent for packaging process, a removing agent for adhesive substances of wafer, an etchant, a post-etch residue stripper, an ash residue cleaner, a PR residue stripper, a CMP cleaner, a post-CMP cleaner, or the like.

### Method of Treating Metal-Containing Film and Method of Preparing Semiconductor Device

By using the aforementioned composition, the metal-containing film may be more effectively treated. For example, by contacting the metal-containing film with the composition, at least a portion of the metal-containing film may be etched, cleaned, or polished.

Referring to FIGURE, a method of treating the metal-containing film according to an embodiment may include: preparing a substrate provided with a metal-containing film (S100); and contacting the metal-containing film with the composition (S110).

The metal-containing film is the same as described elsewhere herein.

In an embodiment, a metal included in the metal-containing film may include Ti, In, Al, Co, La, Sc, Ga, W, Mo, Ru, Zn, Hf, Cu, or any combination thereof.

The metal-containing film may include a metal, metal nitride, metal oxide, metal oxynitride, or a combination thereof.

In an embodiment, the metal-containing film may include a metal, metal nitride, metal oxide, metal oxynitride, or any combination thereof, and a metal included in each of the metal, the metal nitride, the metal oxide, and the metal oxynitride may include Ti, In, Al, Co, La, Sc, Ga, W, Mo, Ru, Zn, Hf, Cu, or any combination thereof.

In one or more embodiments, the metal-containing film may include a metal oxide, and the metal oxide may include: i) In, Ga, Zn, or any combination thereof; or ii) Al.

In one or more embodiments, the metal-containing film may include IGZO, aluminum oxide (e.g., Al₂O₃), or a combination thereof.

In the IGZO, an atomic ratio or weight ratio of In, Ga, and Zn may be varied.

In one or more embodiments, the metal-containing film may include a metal. In an embodiment, the metal-containing film may include Al.

In one or more embodiments, the metal-containing film may include IGZO, aluminum oxide, or a combination thereof, and by contacting of the metal-containing film with the composition, residue on a surface of the metal-containing film surface may be removed, thereby cleaning at least a portion of the metal-containing film.

The residues may be by-products produced during deposition and/or patterning of the metal-containing film, and may be substances that remain on the surface of the metal-containing film and/or the surface of patterns of the metal-containing film and accordingly cause an increase in electrical resistance and/or electrical short circuit between electrical wiring. The residue may be an etching residue produced as a result of etching, and may include, for example, an etching gas residue, a polymer residue, a metal-containing residue, or any combination thereof.

The etching gas residue may be derived from etching gas used for dry etching. The etching gas may be, for example, fluorocarbon gas. For example, the etching gas may include CHF₃, C₂F₆, CF₄, C₄F₈, C₂HF₅, and the like. The etching gas residue may include the etching gas itself and/or a reaction product from any substance in contact with the etching gas during an etching process using the etching gas.

The polymer residue may be a polymer derived from various organic substances included in a photoresist, a dielectric layer, a buffer layer, a diffusion barrier layer, etc. used in preparing and/or patterning the metal-containing film. For example, the polymer residue may be a polymer including C, Si, F, or any combination thereof.

The metal-containing residue may be any residue including a metal separated from the metal-containing film during preparation and/or patterning of the metal-containing film.

Since the composition includes the etching controller including the compound represented by Formula 1, the etching rate for various metal-containing films may be more easily controlled.

Meanwhile, referring to the FIGURE, a method of preparing a semiconductor device according to an embodiment may include: preparing a substrate provided with a metal-containing film (S100); contacting the metal-containing film with the composition (S110); and preparing a semiconductor device by performing at least one subsequent manufacturing process (S120).

In an embodiment, the substrate may be provided with a transistor including a channel, and the channel of the transistor may include the metal-containing film. Here, the metal-containing film may include IGZO, and by the contacting of the metal-containing film with the composition, residue on a surface of the metal-containing film may be removed, thereby cleaning at least a portion of the metal-containing film.

### Examples 1 to 4 and Comparative Examples C₁ to C₃

Compositions of Examples 1 to 4 and Comparative Examples C₁ to C₃ were prepared by mixing hydrofluoric acid in the amounts shown in Table 1 with substances as etching controllers in the amount shown in Table 1. The remnants of each composition correspond to water (deionized water).

### Evaluation Example 1

After adding the composition of Example 1 into two beakers, i) a 2 cm×2 cm IGZO film specimen was immersed in the first beaker at 25° C. for 20 seconds, and ii) a 2 cm×2 cm Al₂O₃ film specimen was immersed in the second beaker at 25° C. for 3 minutes. Then, a thickness of each of the IGZO film and the Al₂O₃ film was measured by using an ellipsometer (M-2000, J.A.Woolam), to evaluate the etching rates (Å/min) of the composition of Example 1 for the IGZO film and the Al₂O₃ film, and the results are summarized in Table 1 together with pH of the composition of Example 1 measured by a pH meter. Subsequently, the surfaces of the immersed IGZO film and the immersed Al₂O₃ film were observed through a transmission electron microscope (TEM) to evaluate whether residues were removed, and the results are summarized in Table 1. The same test was repeated by using the compositions of Examples 2 to 4 and Comparative Examples C₁ to C₃, and the results are summarized in Table 1.

TABLE 1

| | | | | | Etching | Etching | | |
|---|---|---|---|---|---|---|---|---|
| | | | | | rate | rate | Removal of | Removal |
| | Amount of | | | | of | of | residue | of |
| | hydrofluoric | | | | IGZO | Al₂O₃ | on | residue |
| | acid | Etching controller | | | film | film | IGZO | on Al₂O₃ |
| | (wt %) | Substance | Amount (wt %) | pH | (Å/min) | (Å/min) | film | film |
| Example 1 | 0.05 | 4 | 0.01 | 2.2 | <1 | 47 | ◯ | ◯ |
| Example 2 | 0.05 | 4 | 1 | 1.5 | <1 | 23 | ◯ | ◯ |
| Example 3 | 0.05 | 4 | 3 | 1.2 | <1 | 12 | ◯ | ◯ |
| Example 4 | 0.05 | 4 | 5 | 0.96 | <1 | 10 | ◯ | ◯ |
| Comparative | 0.05 | — | 0 | 2.2 | 1460 | 61 | X | X |
| Example C1 | | | | | | | | |
| Comparative | 0.05 | A1 | 0.01 | 2.3 | 1380 | 60 | X | X |
| Example C2 | | | | | | | | |
| Comparative | 0.05 | A5 | 0.01 | 2.3 | 1060 | 58 | X | X |
| Example C3 | | | | | | | | |

◯: Most of residues are removed
X: Significant amount of residues remain

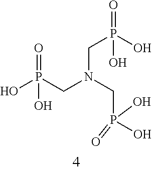 [SMILES: O=P(O)(O)CN(CP(=O)(O)O)CP(=O)(O)O]

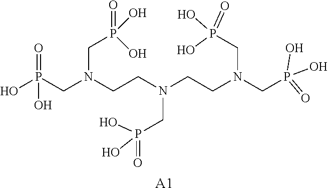

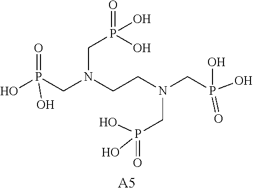

Referring to Table 1, it was confirmed that, compared to the compositions of Comparative Examples C₁ to C₃, the compositions of Examples 1 to 4 had improved and/or excellent etching suppression performance and/or cleaning performance at the same time for each of the IGZO film and the Al₂O₃ film.

### Examples 5 and 6 and Comparative Examples C₄ and C₅

Compositions of Examples 5 and 6 and Comparative Examples C₄ and C₅ were prepared by mixing hydrofluoric acid in the amounts shown in Table 2 with substances as etching controllers in the amount shown in Table 2. The remnants of each composition correspond to water (deionized water).

### Evaluation Example 2

Using the same method as Evaluation Example 1, regarding the compositions of Examples 5 and 6 and Comparative Examples C4 and C5, the pH, etching rate for the IGZO film, and etching rate for the Al₂O₃ film were evaluated, and the results are summarized in Table 2.

TABLE 2

| | Amount | | | | Etching | Etching |
|---|---|---|---|---|---|---|
| | of | Etching | | | rate of | rate of |
| | hydrofluoric | controller | | | IGZO | Al₂O₃ |
| | acid | Sub- | Amount | | film | film |
| | (wt %) | stance | (wt %) | pH | (Å/min) | (Å/min) |
| Example 5 | 0.05 | 12 | 0.01 | 2.4 | 770 | 48 |
| Example 6 | 0.05 | 11 | 0.01 | 2.4 | 77 | 45 |
| Comparative | 0.05 | A2 | 0.01 | 2.4 | 1460 | 59 |
| Example C4 | | | | | | |
| Comparative | 0.05 | A4 | 0.01 | 2.4 | 1400 | 60 |
| Example C5 | | | | | | |

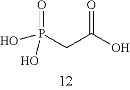

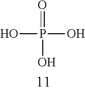

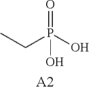

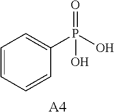

Referring to Table 2, it was confirmed that the compositions of Examples 5 and 6 had improved and/or excellent etching suppression performance for the IGZO film and the Al₂O₃ film, compared to the compositions of Comparative Examples C4 and C5.

### Examples 7 to 13 and Comparative Example C6

Compositions of Examples 7 to 13 and Comparative Example C6 were prepared by mixing hydrofluoric acid in the amounts shown in Table 3 with substances as etching controllers in the amount shown in Table 3. The remnants of each composition correspond to water (deionized water).

### Evaluation Example 3

Using the same method as Evaluation Example 1, regarding the compositions of Examples 7 to 13 and Comparative Example C6, the pH, etching rate for the IGZO film, and etching rate for the Al₂O₃ film were evaluated, and the results are summarized in Table 3. For comparison, data from Example 4 are shown in Table 3.

TABLE 3

| | Amount | | | | | |
|---|---|---|---|---|---|---|
| | of | | | | Etching | Etching |
| | hydro- | | | | rate of | rate of |
| | fluoric | Etching controller | | | IGZO | Al₂O₃ |
| | acid | Sub- | Amount | | film | film |
| | (wt %) | stance | (wt %) | pH | (Å/min) | (Å/min) |
| Example 4 | 0.05 | 4 | 5 | 0.96 | <1 | 10 |
| Example 7 | 0.05 | 3 | 5 | 1.1 | 10 | 12 |
| Example 8 | 0.05 | 2 | 5 | 0.98 | <1 | 7 |
| Example 9 | 0.05 | 2 | 3 | 1.2 | <1 | 10 |
| Example 10 | 0.05 | 2 | 1 | 1.6 | <1 | 23 |
| Example 11 | 0.05 | 2 | 0.5 | 2.1 | <1 | 39 |
| Example 12 | 0.05 | 2 | 0.1 | 2.3 | <1 | 41 |
| Example 13 | 0.05 | 2 | 0.01 | 2.4 | <1 | 43 |
| Comparative | 0.05 | A3 | 5 | 1.8 | 1400 | 48 |
| Example C6 | | | | | | |

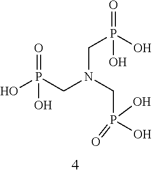 [SMILES: O=P(O)(O)CN(CP(=O)(O)O)CP(=O)(O)O]

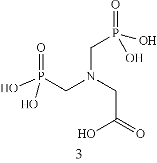 [SMILES: O=C(O)CN(CP(=O)(O)O)CP(=O)(O)O]

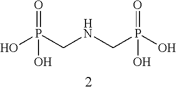 [SMILES: O=P(O)(O)CNCP(=O)(O)O]

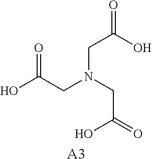

Referring to Table 3, it was confirmed that the compositions of Examples 4 and 7 to 13 had improved and/or excellent etching suppression performance for the IGZO film and the Al₂O₃ film, compared to the composition of Comparative Example C6.

### Comparative Examples C7 and C8

Compositions of Comparative Examples C7 and C8 were prepared by mixing hydrogen peroxide and hydrofluoric acid in the amounts shown in Table 4 with substances as etching controllers in the amount shown in Table 4. The remnants of each composition correspond to water (deionized water).

### Evaluation Example 4

Using the same method as Evaluation Example 1, regarding the compositions of Comparative Examples C7 and C8, the pH, etching rate for the IGZO film, and etching rate for the Al₂O₃ film were evaluated, and the results are summarized in Table 4. For comparison, data from Example 4 are shown in Table 4.

TABLE 4

| | | Amount | | | | Etching | Etching |
|---|---|---|---|---|---|---|---|
| | Amount | of | | | | rate | rate |
| | of | hydro- | Etching | | | of | of |
| | hydrogen | fluoric | controller | | | IGZO | Al₂O₃ |
| | peroxide | acid | Sub- | Amount | | film | film |
| | (wt %) | (wt %) | stance | (wt %) | pH | (Å/min) | (Å/min) |
| Example | 0 | 0.05 | 4 | 5 | 0.96 | <1 | 10 |
| 4 | | | | | | | |
| Com- | 20 | 0.05 | 4 | 5 | <1 | 8.8 | 24 |
| parative | | | | | | | |
| Example | | | | | | | |
| C7 | | | | | | | |
| Com- | 20 | 0.1 | 4 | 5 | <1 | 65.7 | 36 |
| parative | | | | | | | |
| Example | | | | | | | |
| C8 | | | | | | | |

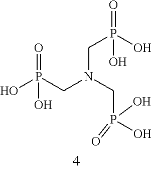 [SMILES: O=P(O)(O)CN(CP(=O)(O)O)CP(=O)(O)O]

Referring to Table 4, it was confirmed that the composition of Example 4 had improved and/or excellent etching suppression performance for the IGZO film and the Al₂O₃ film, compared to the compositions of Comparative Examples C7 and C8.

### Example 14

A composition of Example 14 was prepared by mixing hydrofluoric acid in the amounts shown in Table 5 with substances as etching controllers in the amount shown in Table 5. The remnants of each composition correspond to water (deionized water).

### Comparative Examples C9 and C10

Compositions of Comparative Examples C9 and C10 were prepared by mixing ammonium bifluoride in the amounts shown in Table 5 with substances as etching controllers in the amount shown in Table 5. The remnants of each composition correspond to water (deionized water).

### Evaluation Example 5

Using the same method as Evaluation Example 1, regarding the compositions of Example 14 and Comparative Examples C9 and C10, the pH, etching rate for the IGZO film, and etching rate for the Al₂O₃ film were evaluated, and the results are summarized in Table 5. For comparison, data from Example 4 are shown in Table 4.

TABLE 5

| | | | | | | Etching | Etching |
|---|---|---|---|---|---|---|---|
| | | | Etching | | | rate of | rate of |
| | Fluorinated | | controller | | | IGZO | Al₂O₃ |
| | compound | Amount | Sub- | Amount | | film | film |
| | Substance | (wt %) | stance | (wt %) | pH | (Å/min) | (Å/min) |
| Example | Hydro- | 0.05 | 4 | 5 | 0.96 | <1 | 10 |
| 4 | fluoric | | | | | | |
| | acid | | | | | | |
| Com- | Ammonium | 0.05 | 4 | 5 | 1.1 | 58.2 | 15 |
| parative | bifluoride | | | | | | |
| Example | | | | | | | |
| C9 | | | | | | | |
| Example | Hydro- | 0.05 | 13 | 5 | 1.19 | 100 | 21 |
| 14 | fluoric | | | | | | |
| | acid | | | | | | |
| Com- | Ammonium | 0.05 | 13 | 5 | 1.12 | 139.4 | 27 |
| parative | bifluoride | | | | | | |
| Example | | | | | | | |
| C10 | | | | | | | |

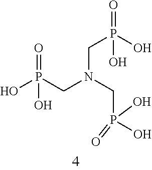 [SMILES: O=P(O)(O)CN(CP(=O)(O)O)CP(=O)(O)O]

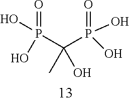

Referring to Table 5, it was confirmed that the composition of Example 4 had improved and/or excellent etching suppression performance for the IGZO film and the Al₂O₃ film compared to the composition of Comparative Example C9, and that the composition of Example 14 had improved and/or excellent etching suppression performance for the IGZO film and the Al₂O₃ film compared to the composition of Comparative Example C10.

According to the one or more embodiments, the composition of the disclosure allows easier control of an etching rate for various metal-containing films, such as a metal-containing film including a metal oxide, and may have improved and/or excellent cleaning performance, and thus may be more effectively used in various treatment processes for the metal-containing film, such as etching, cleaning, and polishing processes. When the metal-containing film is treated by using the composition, a higher-quality semiconductor device may be prepared.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A composition comprising
hydrofluoric acid; and
an etching controller, wherein
the composition does not substantially include hydrogen peroxide,
the etching controller comprises at least one compound represented by Formula 1, 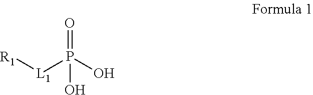
wherein, in Formula 1,
L₁ is a single bond, *—O—*, *—S—*′, or a C₁-C₁₀ alkylene group,
R₁ is *—OH, *—C(═O)—OH, *—P(═O)(OH)₂, or *—N(L₁₁-R₁₁)(L₁₂-R₁₂),
L₁₁ and L₁₂ are each independently a single bond or a C₁-C₁₀ alkylene group,
R₁₁ and R₁₂ are each independently hydrogen, *—OH, *—C(═O)—OH, *—P(═O)(OH)₂, or *—NH₂,
in L₁, L₁₁ and L₁₂, at least one hydrogen in the C₁-C₁₀ alkylene group is optionally substituted with a C₁-C₁₀ alkyl group, *—OH, *—C(═O)—OH, *—P(═O)(OH)₂, or *—NH₂,
* and *′ each indicate a binding site to a neighboring atom, and
a number of groups represented by *—P(═O)(OH)₂ in Formula 1 is 1, 2, or 3.

2. The composition of claim 1, wherein
an amount of the hydrofluoric acid is in a range of about 0.01 wt % to about 2 wt % with respect to 100 wt % of the composition.

3. The composition of claim 1, wherein
an amount of the hydrofluoric acid is in a range of about 0.01 wt % to about 0.1 wt % with respect to 100 wt % of the composition.

4. The composition of claim 1, wherein L₁ in Formula 1 is:
a single bond, *—O—*′, or a C₁-C₆ alkylene group; or
a C₁-C₆ alkylene group substituted with at least one of a C₁-C₁₀ alkyl group, *—OH, *—C(═O)—OH, *—P(═O)(OH)₂, and *—NH₂.

5. The composition of claim 1, wherein
R₁ in Formula 1 is *—OH, *—C(═O)—OH, or *—P(═O)(OH)₂.

6. The composition of claim 1, wherein,
in Formula 1, R₁ is *—N(L₁₁-R₁₁)(L₁₂-R₁₂),
L₁₁ and L₁₂ are each independently:
a single bond or a C₁-C₆ alkylene group; or
a C₁-C₆ alkylene group substituted with at least one of a C₁-C₁₀ alkyl group, *—OH, *—C(═O)—OH, *—P(═O)(OH)₂, and *—NH₂,
R₁₁ is hydrogen or *—P(═O)(OH)₂, and
R₁₂ is hydrogen, *—OH, *—C(═O)—OH, *—P(═O)(OH)₂, or *—NH₂.

7. The composition of claim 1, wherein the etching controller comprises at least one of Compounds 1 to 13:

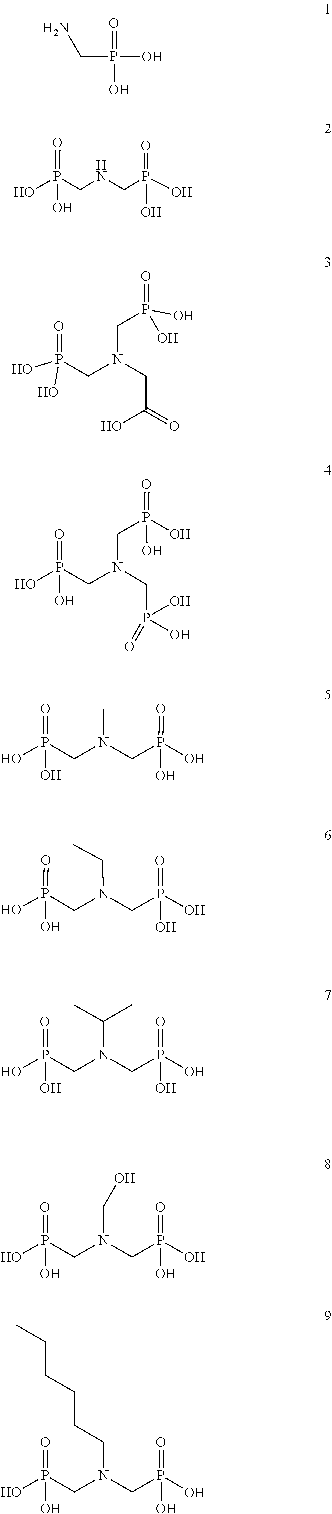

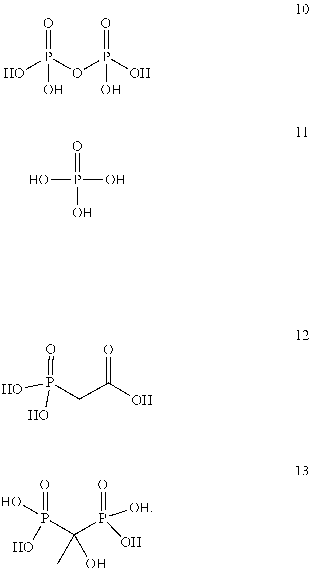

8. The composition of claim 1, wherein
an amount of the etching controller is in a range of about 0.001 wt % to about 10 wt % with respect to 100 wt % of the composition.

9. The composition of claim 1, wherein
an amount of the hydrofluoric acid is in a range of about 0.03 wt % to about 0.07 wt % with respect to 100 wt % of the composition, and
an amount of the etching controller is in a range of about 0.005 wt % to about 7 wt % with respect to 100 wt % of the composition.

10. The composition of claim 1, wherein
the composition has a pH of 3.0 or less.

11. A method of treating a metal-containing film, the method comprising:
preparing a substrate including a metal-containing film thereon; and
contacting the metal-containing film with the composition of claim 1.

12. The method of claim 11, wherein
during the contacting the metal-containing film with the composition, at least a portion of the metal-containing film is etched, cleaned, or polished.

13. The method of claim 11, wherein
the metal-containing film comprises titanium (Ti), indium (In), aluminum (Al), cobalt (Co), lanthanum (La), scandium (Sc), gallium (Ga), tungsten (W), molybdenum (Mo), ruthenium (Ru), zinc (Zn), hafnium (Hf), copper (Cu), or any combination thereof.

14. The method of claim 11, wherein
the metal-containing film comprises a metal, a metal nitride, a metal oxide, a metal oxynitride, or any combination thereof.

15. The method of claim 11, wherein
the metal-containing film includes a metal oxide, and
the metal oxide includes indium, gallium, zinc, or any combination thereof, or
the metal oxide includes aluminum.

16. The method of claim 11, wherein
the metal-containing film includes indium gallium zinc oxide (IGZO), aluminum oxide, or a combination thereof.

17. The method of claim 11, wherein
the metal-containing film includes aluminum.

18. The method of claim 11, wherein
the metal-containing film includes indium gallium zinc oxide (IGZO), aluminum oxide, or a combination thereof, and
during the contacting the metal-containing film with the composition, at least a portion of the metal-containing film is cleaned by removing residue on a surface of the metal-containing film.

19. A method of preparing a semiconductor device, the method comprising:
preparing a substrate including a metal-containing film;
contacting the metal-containing film with the composition of claim 1; and
preparing the semiconductor device by performing at least one subsequent manufacturing process.

20. The method of claim 19, wherein
the substrate has a transistor including a channel,
the channel of the transistor comprises the metal-containing film,
the metal-containing film comprises indium gallium zinc oxide (IGZO), and
during the contacting of the metal-containing film with the composition, at least a portion of the metal-containing film is cleaned by removing residue on a surface of the metal-containing film.
